(19) United States
(12) Patent Application Publication
(10) Pub. No.: US 2023/0373451 A1
(43) Pub. Date: Nov. 23, 2023

(54) AXIAL FORCE TRANSMITTER FOR AN ACTUATING DEVICE OF A BRAKE SYSTEM AND A METHOD FOR PRODUCING AN AXIAL FORCE TRANSMITTER

(71) Applicant: Robert Bosch GmbH, Stuttgart (DE)

(72) Inventors: Armin Kuran, Sonthofen (DE); Karl-Heinz Roos, Blaichach (DE); Leri Wolfgang Rittel Virgilio, Schweinfurt (DE); Maximilian Wilhelm, Buchenberg (DE)

(21) Appl. No.: 18/246,900

(22) PCT Filed: Sep. 28, 2021
(86) PCT No.: PCT/EP2021/076555

§ 371 Date: Mar. 28, 2023

(30) Foreign Application Priority Data
Nov. 25, 2020 (DE) 10 2020 214 793.0

(51) Int. Cl. B60T 11/04; G05G 1/46

(52) U.S. Cl. CPC B60T 11/04; G05G 1/46

(57) ABSTRACT

An axial force transmitter for an actuating device of a brake system. The axial force transmitter includes an elongate first component, and an elongate second component, wherein the first component has a sleeve portion, a first end portion of the second component axially protruding into the sleeve portion, and wherein the sleeve portion and the first end portion of the second component are connected to each other in an axially fixed manner. The sleeve portion and the first end portion of the second component are connected to each other in an axially fixed manner by pressure forming of the sleeve portion. A method of producing an axial force transmitter is also described.

### FIELD

The present invention relates to an axial force transmitter for an actuating device of a brake system, comprising an elongate first component and an elongate second component, wherein the first component has a sleeve portion, wherein a first end portion of the second component axially protrudes into the sleeve portion, and wherein the sleeve portion and the first end portion of the second component are connected to each other in an axially fixed manner.

In addition, the present invention relates to an actuating device for a brake system having such an axial force transmitter.

Further, the present invention relates to a method of producing an axial force transmitter.

### BACKGROUND INFORMATION

A brake system of a motor vehicle typically comprises an actuating device configured to actuate a brake master cylinder of the brake system, i.e., to displace a hydraulic piston supported in the brake master cylinder. Such an actuating device usually comprises a displaceable axial force transmitter, which is coupled to a brake pedal of the brake system. The actuating device is configured to actuate the brake master cylinder as a function of a displacement of the axial force transmitter. Two-part axial force transmitters having an elongate first component and an elongate second component are described in the related art, wherein the first and the second components are connected to each other in an axially fixed manner. Often, the axially fixed connection is achieved by the first component having a sleeve portion into which a first end portion of the second component axially protrudes, wherein the sleeve portion and the first end portion of the second component are then connected to each other in an axially fixed manner.

In conventional axial force transmitters, the axially fixed connection is generally provided by a screw connection. In this respect, the sleeve portion then comprises an internal thread and the first end portion of the second component comprises an external thread which is screwed into the internal thread.

### SUMMARY

An axial force transmitter according to the present invention may have an advantage that the structural design of the first and the second components can be simplified compared to conventional solutions. This provides advantages with regard to the production of the first component and the second component. According to an example embodiment of the present invention, it is provided that the sleeve portion and the first end portion of the second component are connected to each other in an axially fixed manner by means of pressure forming of the sleeve portion. Pressure forming is a method in which a component is subjected to a pressing force such that the component deforms. The component is thus deformed by pressure. In this respect, the sleeve portion comprises at least one deformed region, wherein said deformed region provides at least in part the axially fixed connection. Because the components are connected to each other by means of pressure forming, the aforementioned threads as well as spanner flats for torque transfer when screwing together are not necessary. Preferably, the threads as well as the spanner flats are omitted. This in particular results in the simplification of the structural design of the components according to the present invention. The first component is an elongate component. In this respect, the first component has a longitudinal central axis. When the terms “axial” and “radial” are used in the context of the disclosure, these terms generally refer to the longitudinal central axis of the first component, unless otherwise expressly disclosed. The second component is also an elongate component. In this respect, the second component also has a longitudinal central axis. Preferably, the components are connected to one another such that the two longitudinal central axes align with each other. The first and second components are then coaxial with each other. Particularly preferably, the first and/or the second component are configured rotationally symmetrically relative to the respective longitudinal central axis at least before the formation of the axially fixed connection. The first and second components are connected to each other in an axially fixed manner. In this respect, the components are connected to each other by a connection that is configured to transfer axial forces, i.e. compressive forces as well as tensile forces in the axial direction.

According to an example embodiment of the present invention, preferably, the sleeve portion comprises at least one radially inwardly projecting bulge for forming the axially fixed connection. The bulge is a deformed region of the sleeve portion or a deformed region of a sleeve wall or sheath wall of the sleeve portion. In this respect, the bulge was produced by pressure forming the sleeve portion using a radially inwardly acting pressing force. Preferably, the axially fixed connection is effected at least in part by positive locking. In this respect, the radially inwardly projecting bulge radially engages with a radial recess of the first end portion of the second component. In such a configuration, particularly high axial forces are transmissible by the axially fixed connection. Preferably, the axially fixed connection is effected at least in part by non-positive locking.

According to an example embodiment of the present invention, preferably, the sleeve portion comprises multiple radially inwardly projecting bulges that are evenly distributed in the circumferential direction of the sleeve portion. A particularly stable axially fixed connection is thereby provided. Particularly preferably, the sleeve portion comprises exactly three radially inwardly projecting bulges. Preferably, the bulges have an at least substantially circular cross-section. In this respect, the bulges were produced by pressure forming by means of a press punch with a circular stamp surface. Preferably, the deformed sleeve portion is rotationally symmetrical with an n-fold axis of rotation, where n corresponds to the number of bulges. Such a rotationally symmetric sleeve section is obtained when the plurality of bulges are shaped simultaneously, i.e. when the sleeve portion is simultaneously subjected to a pressing force at multiple locations which are evenly distributed in the circumferential direction of the sleeve portion.

According to a preferred embodiment of the present invention, it is provided that the first end portion of the second component and the sleeve portion are connected to each other in an axially fixed manner by means of pressure forming of the first end portion. In this respect, at least one region of the first end portion is also deformed and the axially fixed connection is provided by deforming the first end portion of the second component. Preferably, the first end portion of the second component comprises a number of dents corresponding to the number of bulges, wherein each of the bulges radially engages a different one of the dents. The aforementioned radial recesses are then formed by the dents. If, for example, the sleeve portion comprises exactly three bulges, the first end portion of the second component comprises a triangular cross-section due to its deformation.

According to a preferred embodiment of the present invention, it is provided that the second component comprises an axial bore. By providing the axial bore, the deformation of the second component is simplified. In this respect, lower pressing forces are necessary for providing the axially fixed connection during the pressure forming.

Preferably, the second component comprises a groove which extends circumferentially through the second component, wherein the bulge radially engages the groove to form the axially fixed connection. This embodiment is particularly advantageous if the second component is made of a harder material than the first component, so that a deformation of the second component is made more difficult. The aforementioned radial recess is then formed by the groove.

According to a preferred embodiment of the present invention, it is provided that an end face of the second component axially abuts a bottom axially delimiting the sleeve portion. Due to the axial abutment of the end face on the bottom, particularly high pressing forces are transferable by the axial force transmitter. According to this embodiment, an end face of the sleeve portion is preferably free so that the second component does not axially abut the end face of the sleeve portion.

According to an alternative embodiment of the present invention, it is preferably provided that the second component comprises an axial stop that axially abuts the end face of the sleeve portion. In this respect, the first end portion of the second component comprises a lower radial extension than a base body of the second component comprising the axial stop. In this respect, the second component is configured in a stepped fashion. Due to the axial abutment of the axial stop on the end face of the sleeve portion, particularly high pressing forces are transferable by the axial force transmitter. The stepped configuration of the second component can also reduce the radial extension of the sleeve portion of the first component because the sleeve portion only has to axially receive the first end portion with the lower radial extension.

The actuating device according to an example embodiment of the present invention for a brake system comprises a displaceable axial force transmitter, which can be coupled or is coupled to a brake pedal. The actuating device has the configuration of the axial force transmitter according to the present invention. This, too, results in the aforementioned advantages. Further preferred features and combinations of features result from the disclosure herein.

According to a preferred embodiment of the present invention, it is provided that the second component is arranged at least in portions in a sleeve-shaped housing portion of the actuating device, wherein the sleeve portion is sized to be displaceable into the housing portion. The radial extension of the sleeve portion is accordingly less than the radial extension of an axial receptacle of the sleeve-shaped housing portion in which the second component is arranged. Because the sleeve portion is also insertable into the sleeve-shaped housing portion, the axial extension of the second component can be reduced. The overall space required for the actuating device can hereby be reduced.

According to an example embodiment of the present invention, preferably, the actuating device comprises a bellows radially enclosing the second component, wherein a first end of the bellows is fixed to the sleeve-shaped housing portion, and wherein a second end of the bellows radially encloses the sleeve portion of the first component and is fixed to the first component. In principle, the bellows prevents soiling from entering an interior of the sleeve-shaped housing portion. Because the bellows also radially encloses the sleeve portion of the first component, the bellows also prevents soiling from entering the region of the axially fixed connection. Preferably, the first end of the bellows is fixed to the sleeve-shaped housing portion by a latching connection. Preferably, the second end of the bellows is fixed to the first component by a latching connection, for example by engaging the second end with a groove of the first component.

According to an example embodiment of the present invention, preferably, the sleeve portion comprises a chamfer for sliding on the bellows. This simplifies the mounting of the bellows.

According to a preferred embodiment of the present invention, it is provided that the first component comprises an axial stop for the second end of the bellows. A secure axial fixation of the bellows on the first component is thereby achieved. In particular, a sliding on of the second end of the bellows beyond the axial stop is prevented.

In a method according to an example embodiment of the present invention for producing an axial force transmitter, an elongate first component is provided having a sleeve portion, an elongate second member is provided, the first and second components are arranged in such a way that a first end portion of the second component axially protrudes into the sleeve portion, and the sleeve portion is deformed by means of pressure forming in such a way that the sleeve portion and the first end portion of the second component are connected to each other in an axially fixed manner. This, too, results in the aforementioned advantages. Further preferred features and combinations of features of the present invention result from the disclosure herein. Preferably, the first end portion of the second component is also deformed along with the sleeve portion being pressure formed. Preferably, a type of clinching method is performed for pressure forming.

According to a preferred embodiment of the method of the present invention, it is provided that the sleeve portion for pressure forming is simultaneously subjected to a pressing force at multiple locations which are evenly distributed in the circumferential direction of the sleeve portion. This prevents unilateral deformations of the components. Rather, by the deformation, a sleeve portion is obtained that is rotationally symmetrical with an n-fold rotational axis, where n corresponds to the number of locations that have been subjected to the pressing force. According to an alternative embodiment, the multiple locations are subjected to the pressing force separately in time.

The present invention will be explained in more detail in the following with reference to the figures.

### BRIEF DESCRIPTION OF THE DRAWINGS

FIG. 1 shows a sectional view of an actuating device according to an example embodiment of the present invention.

FIG. 2 shows embodiment examples of an axial force transmitter of the actuating device which comprises a first and a second component, according to the present invention.

FIG. 3 shows embodiment examples of the second component, according to an example embodiment of the present invention.

FIG. 4 shows a method of producing the axial force transmitter, according to an example embodiment of the present invention.

FIG. 5 shows the first and the second components after releasing an axially fixed connection between the components.

### DETAILED DESCRIPTION OF EXAMPLE EMBODIMENTS

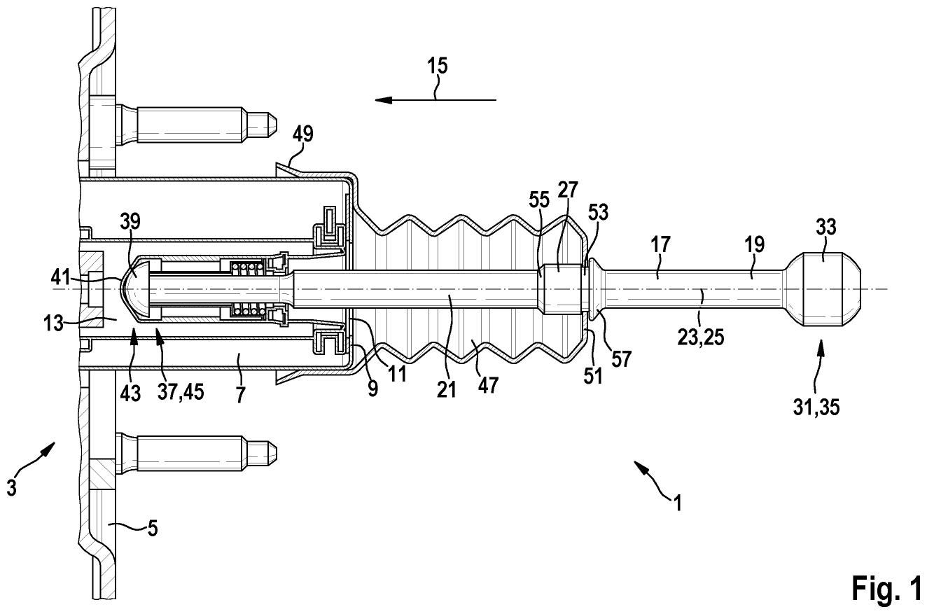

FIG. 1 shows a sectional view of an actuation device 1 of a brake system of a motor vehicle, which is not shown in more detail. The actuating device 1 comprises a housing 3. The housing 3 comprises a housing plate 5 as well as a sleeve-shaped housing portion 7. The housing portion 7 comprises a front plate 9 in which an axial breakthrough 11 is formed. An actuating element 13 is axially displaceably supported in an interior of the housing portion 7. When the actuating element 13 is displaced in an actuating direction 15, a non-depicted brake master cylinder of the brake system is actuated by the actuating element 13.

The actuating device 1 also comprises an axially displaceable axial force transmitter 17. The axial force transmitter 17 comprises an elongate or rod-shaped first component 19 as well as an elongate or rod-shaped second component 21. The components 19 and 21 are arranged coaxially with each other. A longitudinal central axis 23 of the first component 19 thus aligns with a longitudinal central axis 25 of the second component 21.

The components 19 and 21 are connected to each other in an axially fixed manner. In this respect, there is a connection acting between the components 19 and 21, through which axial forces acting in the actuation direction 15 as well as in the opposite direction can be transferred. When, for example, the first component 19 is subjected to an axial force acting in the actuation direction 15, the second component 21 is shifted along with the first component 19 in the actuation direction 15. When, for example, the first component 19 is subjected to an axial force acting counter to the actuation direction 15, the second component 21 is shifted along with the first component 19 in this direction. The components 19 and 21 are rigidly formed. Thus, the axial force transmitter 17 is formed rigidly as a whole. In the present case, the components 19 and 21 are made of a steel material, for example a stainless steel or a coated steel, wherein a Zn coating or a ZnNi coating is provided as a coating, for example.

The first component 19 comprises a sleeve portion 27. A first end portion 29 of the second component 21, which is not visible in FIG. 1, engages axially with the sleeve portion 27. The sleeve portion 27 and the first end portion 29 of the second component 21 are connected to one another in an axially fixed manner by means of pressure forming of the sleeve portion 27.

The sleeve portion 27 was thus subjected to a pressing force at at least one location, through which pressing force the sleeve portion 27 is deformed such that the first component 19 and the second component 21 are connected to each other in an axially fixed manner. Due to the application of the pressing force, the sleeve portion 27 comprises at least one bulge which projects radially towards the first end portion 29 of the second component 21. This bulge engages with a radial recess of the first end portion 29 of the second component 21, wherein different embodiment examples in this regard will be explained in more detail later with reference to FIG. 3. Preferably, the sleeve portion 27 comprises a plurality of bulges that are evenly distributed in the circumferential direction of the sleeve portion 27. Preferably, the bulges have a circular cross-section. Such bulges are obtained when the pressing force is provided by a press punch having a circular punch surface.

The sleeve portion 27 is sized such that the sleeve portion 27 is displaceable into the housing portion 7. The radial extension of the sleeve portion 27 is accordingly less than the radial extension of the axial breakthrough 11.

A second end portion 31 of the first component 19 has a thickening 33 through which the first component 19 can be coupled to a brake pedal of the brake system. The second end portion 31 of the first component 19 corresponds to a rear end of the axial force transmitter 17 in the actuation direction 15. A second end portion 37 of the second component 21 comprises a spherical swivel head 39 which inserts into a ball receptacle 41 of the actuating element 13. Thus, the axial force transmitter 17 is coupled to the actuating element 13 by a ball joint 43. Thus, if the axial force transmitter 17 is axially displaced in the actuation direction 15, the actuating element 13 is shifted along with the axial force transmitter 17. The second end portion 37 of the second component 21 corresponds to a front end 45 of the axial force transmitter 17 in the actuation direction 15.

The actuating device 1 also comprises a bellows 47. The bellows 47 radially encloses a portion of the second component 21 arranged outside the housing portion 7. A first end 49 of the bellows 47 is fixed to the housing portion 7. A second end 51 of the bellows 47 radially encloses the sleeve portion 27 and is fixed to the first component 19. For this purpose, the first component 19 comprises a groove 53 which extends circumferentially through the first component 19 and into which the second end 51 of the bellows 47 is radially latched.

To facilitate sliding the bellows 47 onto the sleeve portion 27, the sleeve portion 27 comprises a sliding chamfer 55. In order to prevent the bellows 47 from being slid forward beyond the groove 53, the first component 19 comprises an axial stop 57. The axial stop 57 is arranged axially between the groove 53 on the one hand and the second end portion 31 of the first component 19 on the other hand and in the present case directly abuts the groove 53.

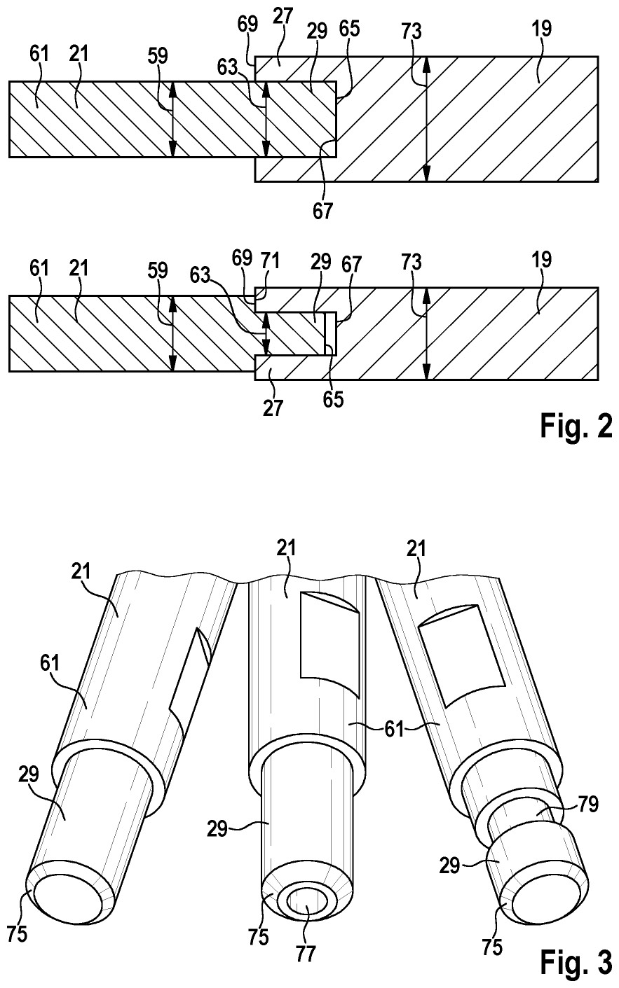

FIG. 2 shows two embodiment examples of the axial force transmitter 17 in a sectional view. The axial force transmitter 17 is shown only schematically. For example, the depiction of the groove 53, the sliding chamfer 55 and the axial stop 57 was omitted.

According to the upper embodiment example, the radial extension 59 of a base body 61 of the second component 21 corresponds to the radial extension 63 of the first end portion 29. The radial extensions 59 and 63 are preferably 6 to 10 mm, in the present case precisely 8 mm. An end face 65 of the first end portion 29 axially abuts a bottom 67 of the first component 19, by which the sleeve portion 27 is bounded in the axial direction. An end face 69 of the sleeve portion 27 is free in the upper embodiment.

According to the lower embodiment example, the second component 21 is configured in a stepped fashion. In this respect, the radial extension 63 of the end portion 29 is less than the radial extension 59 of the base body 61. In the present case, the radial extension 59 is 8 mm and the radial extension 63 is 6 mm. Due to the stepped configuration, the base body 61 comprises an axial stop 71. The axial stop 71 axially abuts the end face 69 of the sleeve portion 27. The end face 65 of the first end portion 19 is axially spaced apart from the bottom 67.

Due to the stepped configuration of the second component 21, the radial extension 73 of the sleeve portion 27 can be reduced in the case of the lower embodiment example. For example, in the lower embodiment example, the radial extension 73 is 8.5 mm and in the upper embodiment example, 10.5 mm. Accordingly, in the present case, the thickness of the sleeve wall of the sleeve portion 27 in both embodiment examples is 1.25 mm.

In FIG. 3, three embodiment examples of the second component 21 are shown which differ from one another in view of the configuration of the first end portion 29. The second components 21 are respectively shown before the axially fixed connection to the first component 19. In addition, the three embodiment examples shown are stepped second components 21, respectively. Alternatively, the first end portions 29 of the second components 21 have the same radial extension as the base body 61, as explained above with reference to FIG. 2. The second components 21 shown in FIG. 3 each comprise an insertion chamfer 75, which facilitates the insertion of the second components 21 into a sleeve portion 27.

According to the left-hand embodiment example, the first end portion 29 is cylindrical. The first end portion 29 thus has the same radial extension at each location, apart from the region in which the insertion chamfer 75 is formed. When the first end portion 29 of the left-hand embodiment example is inserted axially into the sleeve portion 27 and the sleeve portion 27 is subsequently deformed by applying a pressing force to the sleeve portion 27, the radially inwardly projecting bulges form in the sleeve portion. By the bulges, the pressing force is transferred to the first end portion 29 of the second component 21 so that dents form in the first end portion 29 complementary to the bulges, into which the bulges then radially engage.

According to the middle embodiment example, the first end portion 29 is also cylindrical. The middle embodiment example differs from the left embodiment example in that the first end portion 29 has an axial bore 77. By providing the axial bore 77, the pressing force required for the forming is reduced.

In accordance with the right-hand embodiment example, the first end portion 29 comprises a groove 79 that extends circumferentially through the first end portion 29. In this embodiment example, if the sleeve portion 27 is subjected to the pressing force, the resulting bulges of the sleeve portion 27 can radially engage the groove 79. A deformation of the first end portion 29 is therefore not necessary to form a positively-locking axially-fixed connection between the first end portion 29 and the sleeve portion 27. The right-hand embodiment example is particularly advantageous if the first component 21 is made of a particularly hard material, so that a deformation of the first component 21 is made more difficult.

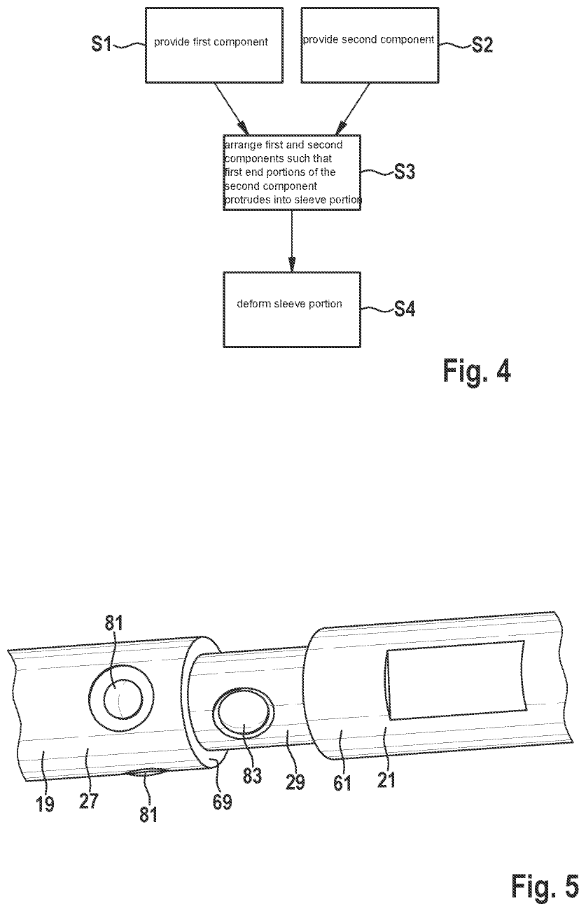

FIG. 4 shows a method for producing the axial force transmitter 17. In a first step S1, the first component 19 is provided. In a second step S2, the second component 21 is provided. In a third step S3, the components 19 and 21 are arranged such that the first end portion 29 of the second component 21 protrudes axially into the sleeve portion 27.

In a fourth step S4, the sleeve portion 27 is deformed by means of pressure forming such that the sleeve portion 27 and the first end portion 29 of the second component 21 are connected to each other in an axially fixed manner. For this purpose, the sleeve portion 27 is subjected to a pressing force acting radially inwardly, i.e. in the direction of the second component 21, at least at one location. As a result, a radially inwardly projecting bulge forms in the sleeve portion 27. Preferably, the sleeve portion 27 is simultaneously subjected to a radially inwardly acting pressing force at multiple locations to form multiple bulges. In particular, the second component 21 is also deformed in step S4. This is the case, for example, if a second component 21 is used in accordance with the left or the middle embodiment example of FIG. 3. In particular, the second component 21 remains at least substantially dimensionally stable in step S4. This is the case, for example, if a second component 21 is used in accordance with the right-hand embodiment example of FIG. 3.

Preferably, step S4 is carried out by means of a device comprising a fixed anvil and a press punch which can be moved towards the anvil. Components 19 and 21 are then arranged in step S3 between the anvil on the one hand and the press punch on the other hand, and in step S4, the sleeve portion 27 is subjected to the pressing force by displacing the press punch towards the anvil.

FIG. 5 depicts the first component 19 and the second component 21 after releasing the axially fixed connection between the two components 19 and 21. For this purpose, the connection was subjected to a tensile force exceeding a limiting load of the connection.

In FIG. 5, several of the radially inwardly projecting bulges 81 of the sleeve portion 27 are visible as dents 81. By releasing the axially fixed joint, the bulges 81 were at least partially radially outwardly formed back. In addition, one of the aforementioned dents 83 of the first end portion 29 can be seen.

If the components 19 and 21 are connected to each other in an axially fixed manner, then one of the radially inwardly projecting bulges 81 of the sleeve portion 27 radially engages the dent 83.

1-15. (canceled)

16. An axial force transmitter for an actuating device of a brake system, comprising:
an elongate first component including a sleeve portion;
an elongate second component, wherein a first end portion of the second component axially protrudes into the sleeve portion, and the sleeve portion and the first end portion of the second component are connected to each other in an axially fixed manner using a pressure forming of the sleeve portion.

17. The axial force transmitter according to claim 16, wherein the sleeve portion includes at least one radially inwardly projecting bulge for forming the axially fixed connection.

18. The axial force transmitter according to claim 17, wherein the sleeve portion includes multiple radially inwardly projecting bulges, which are arranged evenly distributed in a circumferential direction of the sleeve portion.

19. The axial force transmitter according to claim 16, wherein the first end portion of the second component and the sleeve portion are connected to each other in an axially fixed manner by means of pressure forming of the first end portion of the second component.

20. The axial force transmitter according to claim 16, wherein the second component includes an axial bore.

21. The axial force transmitter according to claim 17, wherein the second component includes a groove which extends circumferentially through the second component, wherein the bulge radially engages the groove to form the axially fixed connection.

22. The axial force transmitter according to claim 16, wherein an end face of the second component axially abuts against a bottom axially delimiting the sleeve portion.

23. The axial force transmitter according to claim 16, wherein the second component includes an axial stop which axially abuts against an end face of the sleeve portion.

24. An actuating device for a brake system, comprising:
a displaceable axial force transmitter that can be coupled or is coupled to a brake pedal;
wherein the axial force transmitter including:
an elongate first component including a sleeve portion, and
an elongate second component, wherein a first end portion of the second component axially protrudes into the sleeve portion, and the sleeve portion and the first end portion of the second component are connected to each other in an axially fixed manner using a pressure forming of the sleeve portion.

25. The actuating device according to claim 24, wherein the second component is arranged at least in portions in a sleeve-shaped housing portion of the actuating device, and wherein the sleeve portion of the first component is sized such that it can be pushed into the housing portion.

26. The actuating device according to claim 25, further comprising:
a bellows radially enclosing the second component, wherein a first end of the bellows is fixed to the sleeve-shaped housing portion, and wherein a second end of the bellows radially encloses the sleeve portion of the first component and is fixed to the first component.

27. The actuating device according to claim 26, wherein the sleeve portion includes a chamfer for sliding on the bellows.

28. The actuating device according to claim 27, wherein the first component includes an axial stop for the second end of the bellows.

29. A method for producing an axial force transmitter, comprising the following steps:
providing an elongate first component having a sleeve portion;
providing an elongate second component;
arranging the first component and the second component in such a way that a first end portion of the second component axially protrudes into the sleeve portion; and
deforming the sleeve portion by means of pressure forming in such a way that the sleeve portion and the first end portion of the second component are connected to each other in an axially fixed manner.

30. The method according to claim 29, wherein the sleeve portion is simultaneously subjected to a pressing force for pressure forming at multiple locations that are evenly distributed in the circumferential direction of the sleeve portion.
